(19) United States
(12) Patent Application Publication
(10) Pub. No.: US 2025/0088025 A1
(43) Pub. Date: Mar. 13, 2025

(54) Method for Operating an Emergency Charging Device and Emergency Charging Device

(71) Applicant: QISDA CORPORATION, Taoyuan City (TW)

(72) Inventors: Po-Fu Wu, Taoyuan City (TW); Chih-Ming Chang, Taoyuan City (TW)

(73) Assignee: QISDA CORPORATION, Taoyuan City (TW)

(21) Appl. No.: 18/803,473

(22) Filed: Aug. 13, 2024

(30) Foreign Application Priority Data
Sep. 13, 2023 (CN) 202311176329.9

(51) Int. Cl. H02J 7/34; H02J 7/00

(52) U.S. Cl. CPC H02J 7/342; H02J 7/0013

(57) ABSTRACT

A method for operating an emergency charging device includes when a mutual charging switch of the emergency charging device is triggered, setting a plurality of batteries whose power is lower than a predetermined threshold as a target battery group, selecting a battery with a highest capacity from the target battery group as a battery to be recharged, selecting a battery with a capacity lower than the battery to be recharged from the target battery group as a discharge battery, and charging the battery to be recharged from the discharge battery.

### BACKGROUND OF THE INVENTION

### 1. Field of the Invention

The present invention relates to an emergency charging device, and more particularly, a method for operating the emergency charging device.

### 2. Description of the Prior Art

FIG. 1 is a schematic diagram of a prior art method for operating a multi-channel charger 10. The multi-channel charger 10 is connected to a plurality of batteries 100, 102, and 104, and the multi-channel charger 10 is coupled to an AC-to-DC converter 106. When the AC-to-DC converter 106 is coupled to an external AC power source, the multi-channel charger 10 can charge the batteries 100, 102, and 104. Assuming three batteries 100, 102, and 104 are coupled to the multi-channel charger 10, and the battery capacities of the batteries 100, 102, and 104 are 40%, 30%, and 20% respectively, the multi-channel charger 10 will give priority to charge the battery 100 with 40% battery capacity first. After the battery 100 is fully charged, the battery to be recharged would be the battery 102 with 30% battery capacity. After the battery 102 is fully charged, the battery to be recharged would be the battery 104 with 20% battery capacity. In this way, the three standby batteries 100, 102, and 104 are fully charged one after another. However, when there is no external AC power supply and charging of the batteries 100, 102, and 104 is required, or the AC-to-DC converter 106 is unavailable to the batteries 100, 102, and 104, the three batteries 100, 102, and 104 with 40%, 30%, and 20% battery capacities would not be able to supply sufficient power to complete an operation cycle of a drone or another device.

### SUMMARY OF THE INVENTION

A method for operating an emergency charging device comprises when a mutual charging switch of the emergency charging device is triggered, setting a plurality of batteries whose power is lower than a predetermined threshold as a target battery group, selecting a battery with a highest capacity from the target battery group as a battery to be recharged, selecting a battery with a capacity lower than the battery to be recharged from the target battery group as a discharge battery, and charging the battery to be recharged from the discharge battery.

An emergency charging device comprises a mutual charging switch and a multi-channel charger. The mutual charging switch is configured to activate a mutual charging function. The multi-channel charger is configured to connect a group of batteries to set a plurality of batteries in the group of batteries whose power is lower than a predetermined threshold as a target battery group after the mutual charging function is activated. After setting the batteries as the target battery group, the multi-channel charger selects a battery with a highest capacity in the target battery group as a battery to be recharged, selects a battery in the target battery group with a capacity lower than the battery to be recharged as a discharge battery, and charges the battery to be recharged from the discharge battery.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a prior art method for operating a multi-channel charger.

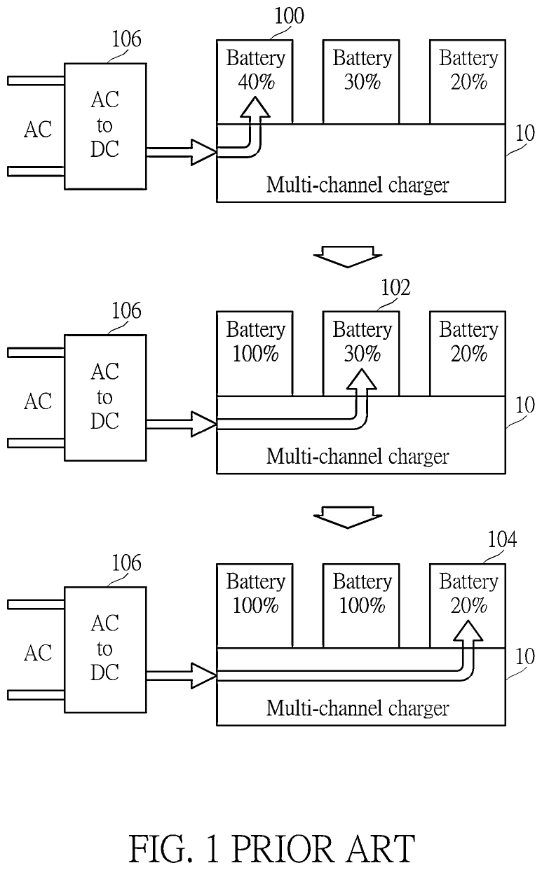

FIG. 2 is a schematic diagram of the emergency charging device according to an embodiment of the present invention.

FIG. 3 is a schematic diagram of the emergency charging device according to another embodiment of the present invention.

FIG. 4 is a schematic diagram of the emergency charging device according to another embodiment of the present invention.

FIG. 5 is a flowchart of a method for operating an emergency charging device according to an embodiment of the present invention.

### DETAILED DESCRIPTION

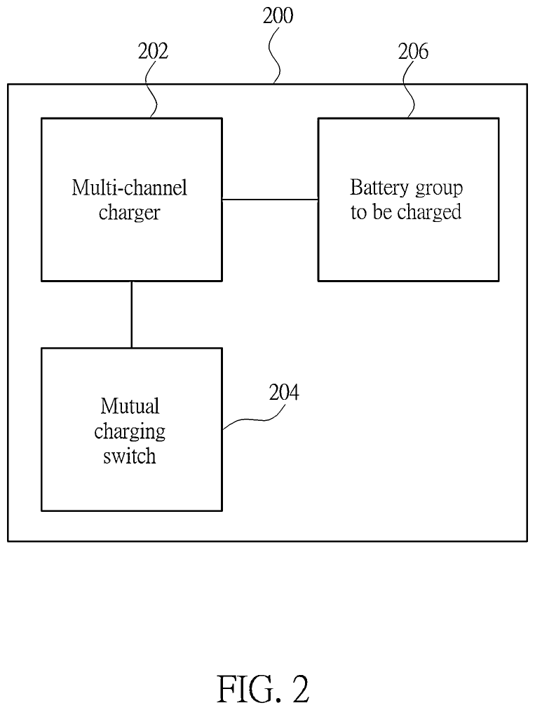

FIG. 2 is a schematic diagram of an emergency charging device 200 according to an embodiment of the present invention. The emergency charging device 200 includes a multi-channel charger 202, a mutual charging switch 204, and a battery pack 206 coupled to the multi-channel charger 202. The multi-channel charger 202 is coupled to the mutual charging switch 204 to activate a mutual charging function. After the mutual charging function is activated, a plurality of batteries of the battery pack 206 whose power is less than a predetermined threshold will be recharged. The plurality of batteries are set as a target battery group, and the multi-channel charger 202 would charge and discharge the target battery group.

Initially, the battery pack 206 is coupled to the multi-channel charger 202. When the mutual charging switch 204 is triggered, a plurality of batteries whose power lower than the predetermined threshold are set as the target battery group. A battery with the highest power is selected from the target battery group as a battery to be recharged, and a battery with a lower capacity is selected from the target battery group as a discharge battery, and the battery to be recharged is charged from the discharge battery. The predetermined threshold can be 50% of battery capacity or a voltage of 3.7V, but is not limited thereto. After the discharge battery is discharged, if the battery to be recharged has not been fully charged, a battery in the target battery group other than fully charged batteries, the battery to be recharged and the discharge battery can be selected as another discharge battery to charge the battery to be recharged. When the battery to be recharged is fully charged, the battery with the highest capacity in the target battery group other than the fully charged batteries can be selected as the battery to be charged. By repeating this loop, the capacities of all batteries in the target battery group are concentrated in a small number of batteries in the target battery group, allowing the user to use the small number of batteries with their full capacity.

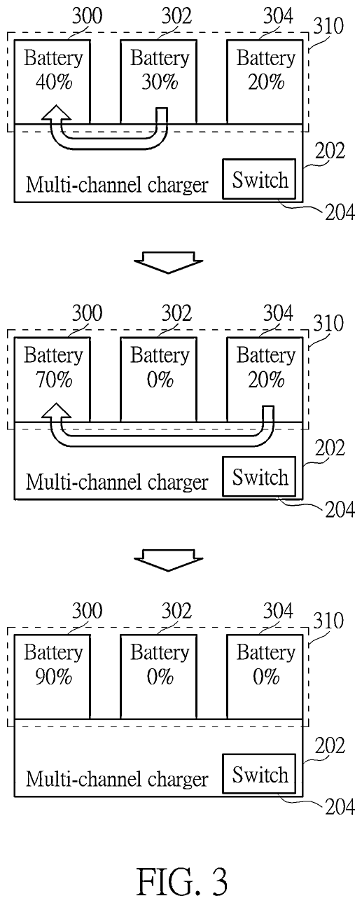

FIG. 3 is a schematic diagram of operating the emergency charging device 200 according to an embodiment of the present invention. In FIG.3, the multi-channel charger 202 is connected to three batteries 300, 302, and 304 to be charged, and there is no external power supply. At this time, when the mutual charging switch 204 of the emergency charging device 200 is triggered, if the predetermined threshold is higher than 40%, such as 50%, then the three batteries with battery capacities of 408, 30%, and 20% will be selected into the target battery group 310. The battery 300 with the highest capacity can be selected as the battery to be recharged, which is the object of the emergency charging device 200, and the battery 302 with the second highest capacity can be selected as the discharge battery. The multi-channel charger 202 charges the battery 300 from the battery 302. When the battery 302 is completely discharged, the battery 302 cannot continue to discharge. At this time, the battery 304 with the next highest capacity other than the fully charged batteries can be selected as the new discharge battery, that is, the battery 304 with 20% capacity can be selected as the new discharge battery. After the battery 304 is completely discharged, 20% of the battery capacity is charged from the discharge battery 304 to the battery 300. Finally, the capacities of the three batteries on the multi-channel charger are 90%, 0%, and 0%, respectively. Thus the battery capacities are all concentrated in the battery 300.

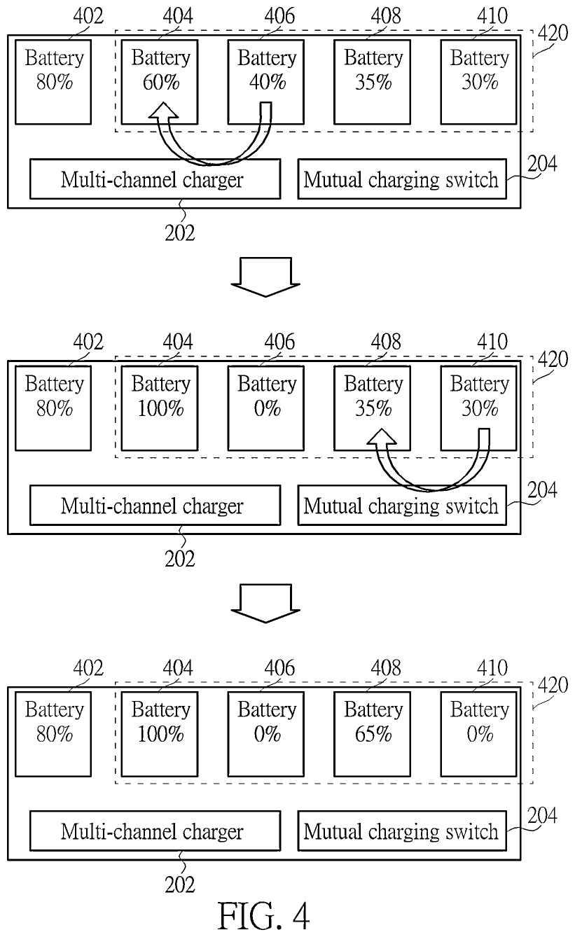

FIG. 4 is a schematic diagram of the emergency charging device 200 according to another embodiment of the present invention. In FIG. 4, the multi-channel charger 202 is coupled to five batteries 402, 404, 406, 408, and 410, and the batteries 402, 404, 406, 408, and 410 are not coupled to an external power supply. When the mutual charging switch 204 of the emergency charging device 200 is triggered, if the predetermined threshold is 70%, all batteries 404, 406, 408, and 410 except the battery 402 with 80% capacity will be selected as the target battery group. In the target battery group 420, the battery 404 with 60% capacity (the highest capacity) can be selected as a battery to be recharged, which is the object of the emergency charging device 200, and the battery 406 with 40% capacity (the second highest capacity) can be selected as a discharge battery. The multi-channel charger 202 charges the battery 404 from the battery 406. When the battery 404 is fully charged (for example, the battery level is 100% or slightly lower than 100%), the multi-channel charger 202 will select a battery 408 with the highest battery capacity other than the fully charged batteries from the target battery group 420 as a new battery to be charged. Since the battery 406 has been completely discharged (for example, the power is 0% or slightly higher than 0%), the battery 410 is neither a fully charged battery nor a battery to be recharged, and the battery 410 has 30% battery capacity, the multi-channel charger 202 would select the battery 410 to be a discharge battery. At last, the battery capacities of all batteries 402, 404, 406, 408, and 410 are 80%, 100%, 0%, 65%, and 0% respectively. Thus the battery capacities are concentrated on a small number of batteries.

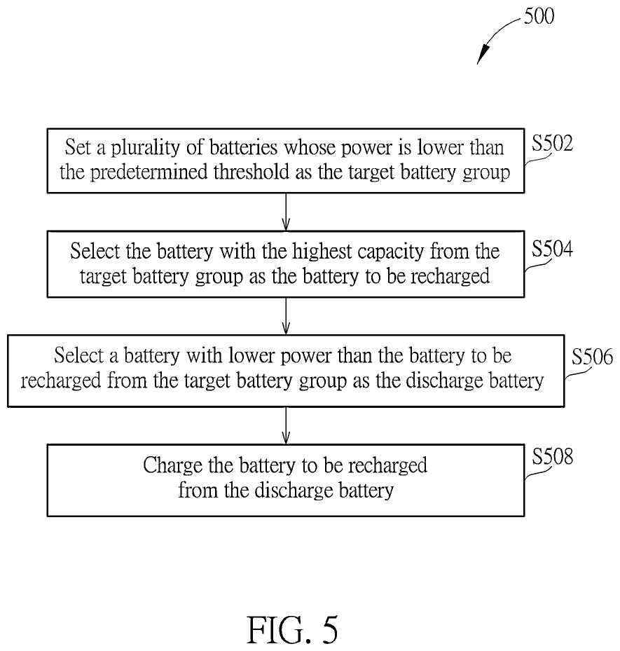

FIG. 5 is a flowchart of a method 500 for operating an emergency charging device 200 according to an embodiment of the present invention. The method 500 includes the following steps:
Step S502: after the mutual charging switch 204 is triggered, set a plurality of batteries whose power is lower than the predetermined threshold as the target battery group;
Step S504: select the battery with the highest capacity from the target battery group as the battery to be recharged;
Step S506: select a battery with power lower than the battery to be recharged from the target battery group as the discharge battery;
Step S508: charge the battery to be charged from the discharge battery.

In step S502, the predetermined threshold may be 50% battery capacity or 3.7V voltage, but is not limited thereto. In step S506, the discharge battery may be the battery with the second highest power in the target battery group, and cannot be a dead battery. After step S508 is completed, when the discharge battery is completely discharged, another battery can be selected from the target battery group as another discharge battery and the battery to be recharged can be charged from the another discharge battery. When the battery to be recharged is fully charged, a battery with the highest capacity other than the fully charged batteries can be selected from the target battery group as another battery to be recharged, and the another battery to be recharged can be charged from the discharge battery.

Through the emergency charging device 200 of the present invention, an emergency charging method can be implemented when an external power supply is unavailable. This allows the battery capacities to be concentrated in a small number of batteries.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for operating an emergency charging device, comprising:
when a mutual charging switch of the emergency charging device is triggered, setting a plurality of batteries whose power is lower than a predetermined threshold as a target battery group;
selecting a battery with a highest capacity from the target battery group as a battery to be recharged;
selecting a battery with a capacity lower than the battery to be recharged from the target battery group as a discharge battery; and
charging the battery to be recharged from the discharge battery.

2. The method of claim 1, wherein the discharge battery is a battery with a second highest power in the target battery group.

3. The method of claim 1, wherein the predetermined threshold is 50% of battery capacity.

4. The method of claim 1, further comprising:
when the discharge battery is completely discharged, selecting another battery from the target battery group as another discharge battery; and
charging the battery to be recharged from the another discharge battery.

5. The method of claim 4, wherein the another discharge battery is a battery with a second highest power in the target battery group, other than fully charged batteries.

6. The method of claim 1, further comprising:
when the battery to be recharged is fully charged, selecting a battery with a highest capacity other than fully charged batteries from the target battery group as another battery to be recharged.

7. An emergency charging device, comprising:
a mutual charging switch, configured to activate a mutual charging function;
a multi-channel charger configured to connect a group of batteries to set a plurality of batteries in the group of batteries whose power is lower than a predetermined threshold as a target battery group after the mutual charging function is activated; and
wherein after setting the batteries as the target battery group, the multi-channel charger selects a battery with a highest capacity in the target battery group as a battery to be recharged, selects a battery in the target battery group with a capacity lower than the battery to be recharged as a discharge battery, and charges the battery to be recharged from the discharge battery.

8. The emergency charging device of claim 7, further comprising:
an external power charger coupled to the multi-channel charger to provide external power to the multi-channel charger.

9. The emergency charging device of claim 7, wherein the discharge battery is a battery with the second highest capacity in the target battery group.

10. The emergency charging device of claim 7, wherein the predetermined threshold is 50% of battery capacity.

11. The emergency charging device of claim 7, wherein when the discharge battery is completely discharged, the multi-channel charger selects another battery in the target battery group as another discharge battery, and charges the battery to be recharged from the another discharge battery.

12. The emergency charging device of claim 11, wherein the another discharge battery is a battery with a second highest capacity in the target battery group other than fully charged batteries.

13. The emergency charging device of claim 7, wherein when the battery to be recharged is fully charged, the multi-channel charger selects a battery with a highest capacity other than fully charged batteries as another battery to be recharged in the target battery group.
